(19) United States
(12) Patent Application Publication
(10) Pub. No.: US 2026/0038799 A1
(43) Pub. Date: Feb. 5, 2026

(54) SYSTEM AND METHOD FOR MANUFACTURING A DRY ELECTRODE

(71) Applicant: SAMSUNG SDI CO., LTD., Yongin-si (KR)

(72) Inventors: Hwan KIM, Yongin-si (KR); Kyungtaek CHOI, Yongin-si (KR); Inyong PARK, Yongin-si (KR)

(21) Appl. No.: 19/215,580

(22) Filed: May 22, 2025

(30) Foreign Application Priority Data
Jul. 31, 2024 (KR) 10-2024-0101591

(51) Int. Cl. H01M 4/04; H01M 4/36

(52) U.S. Cl. CPC H01M 4/0435; H01M 4/366

(57) ABSTRACT

A system for manufacturing a dry electrode and a method of manufacturing the dry electrode are provided. The system may include a supply unit that supplies an electrode powder containing an active material, a calendering unit that presses the electrode powder to form an electrode film, an unwinding unit that supplies a current collector; and a laminating unit that bonds the current collector with the electrode film. The unwinding unit may be disposed at a position below the calendering unit.

### CROSS-REFERENCE TO RELATED APPLICATION

The present application claims priority to and the benefit of Korean Application No. 10-2024-0101591, filed on Jul. 31, 2024, in the Korean Intellectual Property Office, the entire disclosure of which is incorporated by reference herein.

### BACKGROUND

### Field

Aspects of embodiments of the present disclosure relate to a system and a method for manufacturing a dry electrode.

### Description of the Related Art

Unlike primary batteries that are not designed to be recharged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A manufacturing process for such secondary batteries is primarily divided into three stages: an electrode manufacturing process, an electrode assembly manufacturing process, and a formation process. Among these stages, the conventional electrode manufacturing process may be further categorized into several processes including an electrode-mixture mixing process, an electrode coating process, a drying process, a rolling process, a slitting process, and a winding process. The electrode-mixture mixing process includes a procedure for blending components necessary for forming an electrode active layer, where electrochemical reactions occur in the electrode. This involves mixing an electrode active material, which is an essential element for the electrode, with other additives such as conductive agents and fillers, a binder for bonding between powders and adhering to the current collector, and solvents for providing viscosity and dispersing the powders, to create a slurry with fluidity. The mixed composition is referred to as the electrode mixture in a broad sense.

Subsequently, the electrode coating process is performed to apply the electrode mixture onto the current collector that has electrical conductivity, followed by the drying process to remove the solvent contained in the slurry. However, during this drying process, the evaporation of the solvent in the slurry can lead to defects in the electrode active layer, such as pinholes or cracks. Additionally, the phenomenon of powder flotation due to differences in solvent evaporation rates occurs, where the powders in areas that dry first tend to float, creating gaps with areas that dry later, thereby degrading the quality of the electrode.

As a result, there has been research focused on the development of dry electrode manufacturing processes that eliminate the need for solvents.

The above information disclosed in this Background section is for enhancement of understanding of the background of the present disclosure, and therefore, it may contain information that does not constitute related (or prior) art.

### SUMMARY

In view of the above, embodiments of the present disclosure provide a system for manufacturing a dry electrode and a method of manufacturing the dry electrode to solve the aforementioned technical problems.

These and other aspects and features of the present disclosure will be described in or will be apparent from the following description of embodiments of the present disclosure.

A system for manufacturing a dry electrode according to one embodiment of the present disclosure includes a supply unit configured to supply an electrode powder containing an active material; a calendering unit configured to press the electrode powder to form an electrode film; an unwinding unit configured to supply a current collector; and a laminating unit configured to bond the current collector and the electrode film. Further, the unwinding unit is disposed at a position below the calendering unit.

According to one embodiment of the present disclosure, the laminating unit or the calendering unit may be disposed at a position below the supply unit.

According to one embodiment of the present disclosure, the electrode powder may be supplied from the supply unit in a direction perpendicular to a direction in which first electrode film is calendered by the calendering unit.

According to one embodiment of the present disclosure, the system described above may further include a cutting unit configured to trim the first electrode film to a specific width. Further, the cutting unit may be arranged at a distance from the calendering unit.

According to one embodiment of the present disclosure, the cutting unit may include a trimming device, and the trimming device may be disposed at a position below the calendering unit.

According to one embodiment of the present disclosure, the system described above may further include a sensor configured to detect bonding between the current collector and the electrode film. Further, the sensor may be disposed at a position below the laminating unit.

According to one embodiment of the present disclosure, the sensor may include a visual sensor or a thickness sensor.

According to one embodiment of the present disclosure, wherein the supply unit is a first supply unit, the electrode powder is a first electrode powder, the calendaring unit is a first calendaring unit, and the electrode film is a first electrode film, and the system described above may further include a second supply unit configured to supply a second electrode powder containing an active material; and a second calendering unit configured to press the second electrode powder to form a second electrode film.

According to one embodiment of the present disclosure, the laminating unit is a first laminating unit and the system described above may further include a second laminating unit configured to bond the current collector, to which the first electrode film is bonded, with the second electrode film.

According to one embodiment of the present disclosure, the system described above may further include a center position controller (CPC) configured to align a position of either the second electrode film or the current collector before bonding the current collector, to which the first electrode film is bonded, with the second electrode film. Further, the first laminating unit and the second laminating unit may be arranged spaced apart from each other.

According to one embodiment of the present disclosure, the second electrode film may be bonded in positional alignment to the first electrode film disposed on the current collector.

According to one embodiment of the present disclosure, the system described above may further include a cutting unit configured to trim the second electrode film to have a specific width. Further, a trimmed width of the second electrode film may correspond to a trimmed width of the first electrode film.

According to one embodiment of the present disclosure, the system described above may further include a winding unit configured to wind a dry electrode film coated on the current collector.

According to one embodiment of the present disclosure, the system described above may further include a density measurement device configured to detect bonding between the current collector, to which the first electrode film is bonded, and the second electrode film.

A method of manufacturing a dry electrode according to one embodiment of the present disclosure includes supplying an electrode powder containing an active material, producing an electrode film by pressing the electrode powder, supplying a current collector, and bonding the current collector and the electrode film. Further, an unwinding unit that supplies the current collector is disposed at a position below a calendering unit that produces the electrode film.

According to one embodiment of the present disclosure, the supplying of the electrode powder may include supplying the electrode powder in a direction perpendicular to a progress direction of a process of pressing the electrode powder to produce the electrode film.

According to one embodiment of the present disclosure, the method described above may further include trimming the first electrode film to a specific width. Further, the trimming of the electrode film may be performed separately from the producing of the electrode film.

According to one embodiment of the present disclosure, the method described above may further include detecting bonding between the current collector and the electrode film.

According to one embodiment of the present disclosure, the electrode powder is a first electrode powder and the electrode film is a first electrode film, and the method described above may further include supplying a second electrode powder containing an active material; and producing a second electrode film by pressing the second electrode powder.

According to one embodiment of the present disclosure, the method described above may further include bonding the current collector, to which the first electrode film is bonded, with the second electrode film; and aligning a position of either the second electrode film or the current collector, before the bonding of the current collector and the second electrode film.

According to some embodiments of the present disclosure, appropriate positioning of the current collector supply device (the unwinding unit) can prevent the foreign matter generated by the current collector supply device from falling onto the calendering unit. This, in turn, simplifies process conditions for the dry electrode manufacturing process and provides for appropriate movement path of the electrode film.

According to some embodiments of the present disclosure, it is possible to prevent contamination by foreign matter caused by friction and wear of the calendering unit during the cutting (trimming) process of the electrode film in the dry electrode manufacturing system, thereby eliminating defects from occurring on the surface of the electrode film.

According to some embodiments of the present disclosure, it is possible to simplify process conditions and alignment requirements in the process of laminating both sides of the electrode's current collector using separately positioned laminating units, thereby providing a dry electrode with uniform quality.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic view of a dry electrode manufacturing system according to an embodiment of the present disclosure.

FIG. 2 illustrates a relationship between a first supply unit and a first calendering unit according to an embodiment of the present disclosure.

FIG. 3 illustrates the vicinity of a first supply unit and a first calendering unit of a dry electrode manufacturing system according to an embodiment of the present disclosure.

FIG. 4 illustrates the vicinity of an unwinding unit and a first laminating unit in a dry electrode manufacturing system according to an embodiment of the present disclosure.

FIG. 5 illustrates a schematic view of a dry electrode manufacturing system according to an embodiment of the present disclosure.

FIG. 6 illustrates the vicinity of a second calendering unit and a second laminating unit in a dry electrode manufacturing system according to an embodiment of the present disclosure.

FIG. 7 illustrates a first electrode film and a second electrode film according to an embodiment of the present disclosure.

FIG. 8 illustrates a dry electrode manufacturing system according to an embodiment of the present disclosure.

FIG. 9 is a flowchart of a method of manufacturing a dry electrode according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

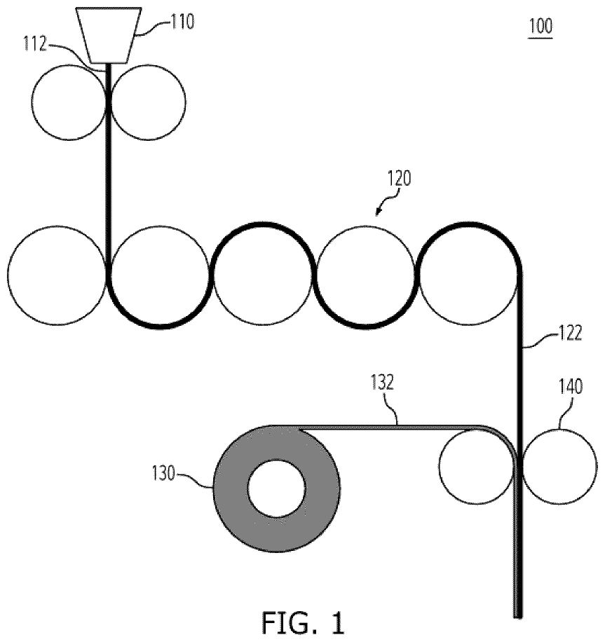

FIG. 1 is a schematic view of a dry electrode manufacturing system according to one embodiment of the present disclosure.

Referring to FIG. 1, a dry electrode manufacturing system 100 according to one embodiment of the present disclosure may include a first supply unit 110 configured to supply a first electrode powder 112 containing an active material. The system 100 may also include a first calendering unit 120 configured to press the first electrode powder 112 to form a first electrode film 122. An unwinding (supplying) unit 130 is configured to supply a current collector 132. A first laminating unit 140 is configured to bond the first electrode film 122 with the current collector 132.

The first supply unit 110 is not particularly limited and serves to store and supply raw materials for the dry electrode. For example, the first supply unit 110 may be a hopper configured to store and uniformly supply the first electrode powder 112 in powder form. The first electrode powder 112 may be mixed and formed within the first supply unit 110, or the first electrode powder 112 may be separately prepared in an external mixer and subsequently transferred to the first supply unit 110.

The first electrode powder 112 may be an amorphous mixture in the form of powder or lumps of combined powder. Specifically, the first electrode powder 112 may include a mixture of an active material (or electrode active material), a conductive material, and a binder. Here, the mixture may be mixed by various methods, including, but not limited to, dry mixing in which the active material, the conductive material, and the binder are mixed in powder form. For example, the mixture may be prepared by placing the materials into a device such as a blender or a kneader.

In one embodiment, the first electrode powder 112 may undergone a fibrillation process to fibrillate the binder. For example, the fibrillation process may include high shear mixing, such as jet milling. The fibrillation process may be conducted under high-temperature conditions. Specifically, the fibrillation process may include kneading the mixture at a temperature ranging from 60° C. to 220° C., preferably from 90° C. to 200° C.

The active material may vary depending on the type of dry electrode to be manufactured. For instance, in a case where the dry electrode to be manufactured is a positive electrode, the active material may be a positive electrode active material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0≤α≤2); LiₐNi_{b}CO_{c}L¹_{d}GₑO₂ (0.90≤a≤1.8, 0≤b≤0.9, 0≤c≤0.5, 0≤d≤0.5, and 0≤α≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

In one embodiment, in a case where the dry electrode to be manufactured is a negative electrode, the active material may be a negative electrode active material.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The above described positive and negative electrode active materials are merely examples, and positive electrode active materials or negative electrode active materials commonly used in the industry may be employed without limitation.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

In one embodiment, the first electrode powder 112 may further include a filler, which serves to suppress the expansion of the electrode. The filler is not particularly limited as long as the filler is a fibrous material that does not cause chemical changes in the battery. Examples of the filler may include olefin-based polymers such as polyethylene or polypropylene, as well as fibrous materials such as glass fiber or carbon fiber.

In one embodiment of the present disclosure, the first calendering unit 120 may be configured to press the first electrode powder 112 to form the first electrode film 122. Specifically, the first calendering unit 120 may produce the first electrode film 122 having a uniform thickness by performing a roll pressing process in which the first electrode powder 112 is passed between a plurality of calender rolls. In one embodiment, the calender rolls may be heated to a temperature ranging from 60° C. to 220° C. In one embodiment, the first electrode film 122 may be a free-standing dry electrode film formed from the first electrode powder 112.

The current collector 132 is not particularly limited as long as the current collector has high conductivity and does not cause chemical changes in the battery. Examples of the current collector 132 include copper, aluminum, stainless steel, nickel, titanium, calcined carbon, or combinations thereof.

In one embodiment, the current collector 132 may be in the form of a metal foil or a thin metal plate, such as copper, a copper alloy, nickel, or a nickel alloy. In another embodiment, the current collector 132 may be formed in the form of a metal foil or a thin metal plate, such as aluminum or an aluminum alloy.

The current collector 132 may be supplied to the first laminating unit 140 by the unwinding unit 130. Here, the unwinding unit 130 may be disposed at a position below the first calendering unit 120. If the unwinding unit 130 that supplies the current collector 132 is positioned above the first calendering unit 120, there may be an increased overall height of the dry electrode manufacturing system 100. The increased height may impose requirements on the height of the ceiling in a place where the dry electrode manufacturing system 100 is installed, thereby affecting the convenience of operators and operational maintenance thereafter.

Further, in a case where the unwinding unit 130 that supplies the current collector 132 is disposed at a position above the first calendering unit 120, there may be interference between the movement path of the current collector 132 and the supply path of the first electrode powder 112 from the first supply unit 110. Still further, in a case where the unwinding unit 130 is driven at a position above the first calendering unit 120 by which the first electrode film 122 is produced, foreign matters generated during the unwinding process of the current collector 132 may fall onto the first calendering unit 120, which may lead to defects in the quality of the first electrode film 122.

As another example, in a case where the current collector 132 is supplied from the side of the first calendering unit 120 to avoid interference between the movement path of the current collector 132 and the supply path of the first electrode powder 112 from the first supply unit 110, the first electrode powder 112 may be supplied unevenly in the width direction of the first electrode film 122, which may lead to defects in the manufactured dry electrode.

According to the embodiments of the present disclosure, the unwinding unit 130 is disposed at a position below the first calendering unit 120, thereby preventing the problems described above.

The first laminating unit 140 may be configured to bond the current collector 132 and the first electrode film 122. Specifically, the first laminating unit 140 may include a pair of opposing presses or a pair of lamination rolls. The first laminating unit 140 may bond the current collector 132 with the first electrode film 122 by placing the current collector 132 and the first electrode film 122 between the pair of presses and applying pressure to them, or by passing the current collector 132 and the first electrode film 122 through the pair of lamination rolls and compressing them. In one embodiment, the presses or the lamination rolls may be heated to a temperature ranging from 80° C. to 250° C. to thermally compress the current collector 132 and the first electrode film 122 together.

In one embodiment, the first laminating unit 140 or the first calendering unit 120 may be disposed at a position below the first supply unit 110.

According to some embodiments of the present disclosure, the appropriate positioning of the unwinding unit 130 that supplies the current collector 132 can prevent the foreign matters generated during the dry electrode manufacturing process from falling onto the first calendering unit 120. This, in turn, simplifies the operation of process conditions for the dry electrode manufacturing process and provides for the movement path of the first electrode film 122.

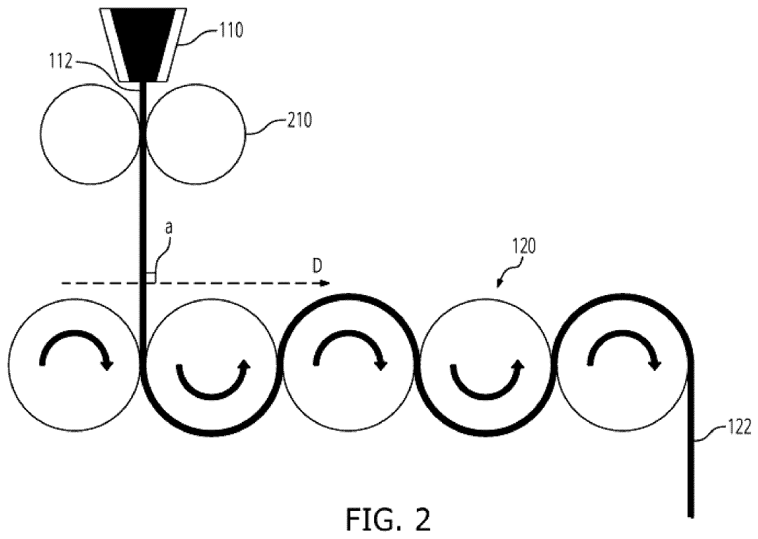

FIG. 2 illustrates the relationship between the first supply unit 110 and the first calendering unit 120 according to one embodiment of the present disclosure.

Referring to FIG. 2, in one embodiment of the present disclosure, the first electrode powder 112 may be supplied from the first supply unit 110. The supply direction of the first electrode powder 112 may be perpendicular to a direction (D) in which the first electrode film 122 is calendered by the first calendering unit 120.

The first electrode powder 112 may be a mixture of various materials, such as an active material, a conductive material, and a binder. Therefore, as the first electrode powder 112 is discharged from the first supply unit 110 and supplied to the first calendering unit 120, a composition ratio of the resulting first electrode film 122 may vary based on an angle (a) formed between the calendering direction (D) and the supplying direction of the first electrode powder 112. Accordingly, in a case where the angle (a) between the calendering direction (D) and the supplying direction of the first electrode powder 112 is 90 degrees, i.e., perpendicular, gravity is uniformly applied to all materials in the mixture, allowing the first electrode film 122 to have a uniform composition ratio.

In an embodiment, before entering the first calendering unit 120, the first electrode powder 112 may be pre-formed by being compressed between a pair of opposing forming rollers 210. Here, the forming rollers 210 may be heated to a temperature ranging from 80° C. to 250° C. Such pre-forming of the first electrode powder 112 may make the composition ratio of the first electrode film 122 more uniform and provide for a smoother surface, thereby preventing the occurrence of cutting sections in the middle of the first electrode film 122.

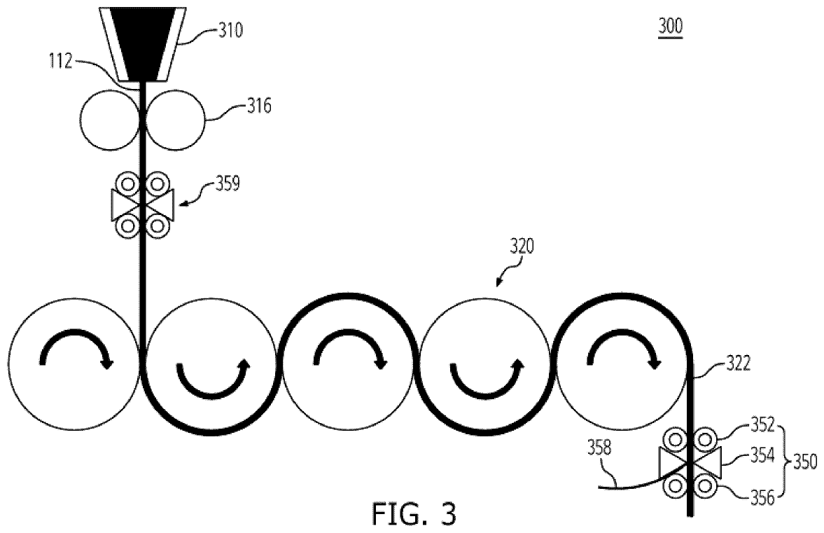

FIG. 3 illustrates the vicinity of a first supply unit and a first calendering unit of a dry electrode manufacturing system according to an embodiment of the present disclosure.

Referring to FIG. 3, a dry electrode manufacturing system 300 according to an embodiment of the present disclosure may further include a first cutting unit 350, which is configured to trim the first electrode film 322 to have a specific width.

The first cutting unit 350 may include a leading alignment roller 352, a trimming device 354, and a trailing alignment roller 356. The leading alignment roller 352 and the trailing alignment roller 356 may serve to adjust an arrangement of the first electrode film 322, enabling the trimming device 354 to cut an intended portion of the first electrode film 322, while also regulating the passage of the first electrode film 322 through the first cutting unit 350 at a constant speed.

In an embodiment, the trimming device 354 may include a pair of opposing blades or laser cutters. As the first electrode film 322 passes between the pair of blades or the laser cutters, a portion of the first electrode film 322 that exceeds a predetermined width may be cut. The trimming device 354 may be disposed at a position below the first calendering unit 320. The cut portion of the first electrode film 322 may be separated and removed as a scrap 358.

Here, ‘scrap’ refers to a material that is removed during the cutting process or is not part of the final product. Specifically, scrap refers to a portion of the first electrode film 322 that is cut off to obtain a desired shape or width of the first electrode film 322. Although not illustrated, an additional process may be carried out to collect and handle the generated scrap. Further, although not illustrated, in one embodiment, a process of supplying cutting oil to a portion of the first electrode film 322 may be carried out before the first cutting unit 350 trims the first electrode film 322.

In an embodiment, the first cutting unit 350 may be arranged at a distance from the first calendering unit 320. In a case where the first cutting unit 350, particularly the trimming device 354 that trims the first electrode film 322, is in contact with the first calendering unit 320, friction may occur between the trimming device 354 and the rotating rollers of the first calendering unit 320. This friction may result in wear of the trimming device 354 or generate foreign matter, leading to defects in the electrode. Further, in a case where the trimming device 354 that trims the first electrode film 322 does not contact the first electrode film 322, there may be a malfunction where the first electrode film 322 is not cut properly.

In an embodiment, the dry electrode manufacturing system 300 may further include a pre-cutting unit 359. The pre-cutting unit 359 may be configured to perform a process of shaping the first electrode powder 312 supplied from the first supply unit 310. Specifically, the first electrode powder 312 may pre-formed by passing through a pair of forming rollers 316, and the pre-formed first electrode powder 312 may be cut by the pre-cutting unit 359 before being supplied to the first calendering unit 320. Such a configuration and process may ensure that the pre-formed first electrode powder 312 has a uniform shape. The configuration of the pre-cutting unit 359 may be the same as that of the first cutting unit 350. The configuration of the pair of forming rollers 316 may be the same as that of the forming rollers 210 shown in FIG. 2.

According to some embodiments of the present disclosure, during the cutting (trimming) process of the first electrode film 322 in the dry electrode manufacturing system 300, it is possible to prevent contamination by foreign matter caused by friction and wear of the first calendering unit 320 and eliminate quality defects occurring on the surface of the first electrode film 322.

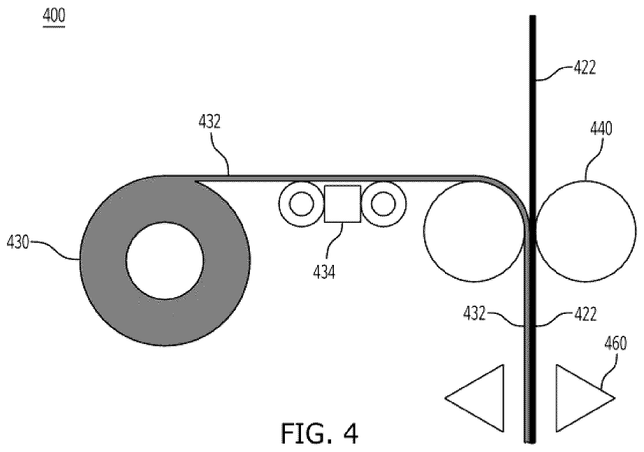

FIG. 4 illustrates the vicinity of an unwinding (supplying) unit 430 and a first laminating unit 440 in a dry electrode manufacturing system 400 according to an embodiment of the present disclosure.

Referring to FIG. 4, the dry electrode manufacturing system 400 according to one embodiment of the present disclosure may further include a first sensor 460 configured to detect the bonding between a current collector 432 and a first electrode film 422. Here, the first sensor 460 may be disposed at a position below the first laminating unit 440.

In one embodiment, the first sensor 460 may include a visual sensor or a thickness sensor. The visual sensor may be a device that inspects a shape, a size, and surface condition of the current collector 432 and the first electrode film 422 using a camera and image processing software. The thickness sensor may be a device that measures a thickness of the current collector 432, to which the first electrode film 422 is bonded, in real-time, to ensure that uniform thickness is maintained. For example, the thickness sensor may include a laser thickness sensor, an ultrasonic thickness sensor, an optical thickness sensor, or a combination thereof.

The dry electrode manufacturing system 400 according to an embodiment of the present disclosure may further include a center position controller (CPC) 434 that aligns a position of the current collector 432 supplied from the unwinding unit 430. Specifically, the CPC 434 may adjust the relative positioning of the current collector 432 in relation to the position of the first electrode film 422 before the current collector 432 is supplied to the first laminating unit 440.

Descriptions of other components of the dry electrode manufacturing system 400 may be referenced from the descriptions provided with reference to FIG. 1.

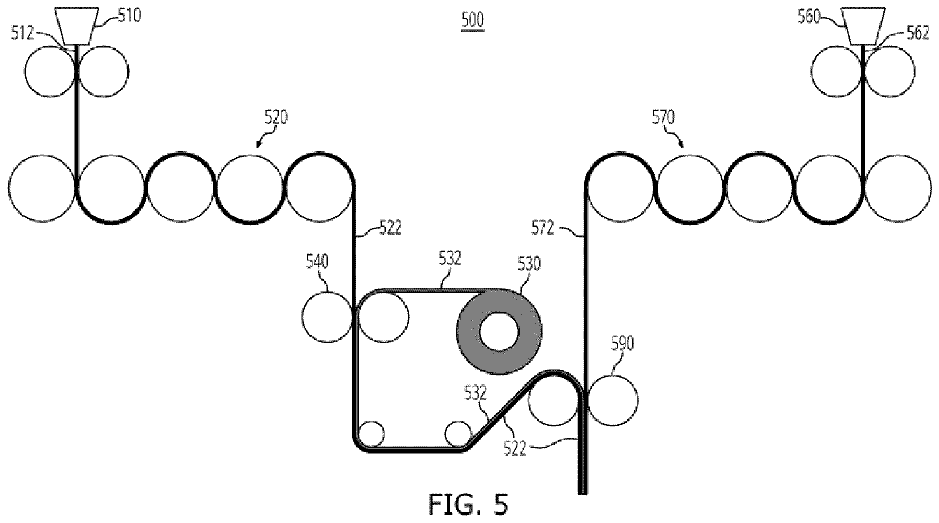

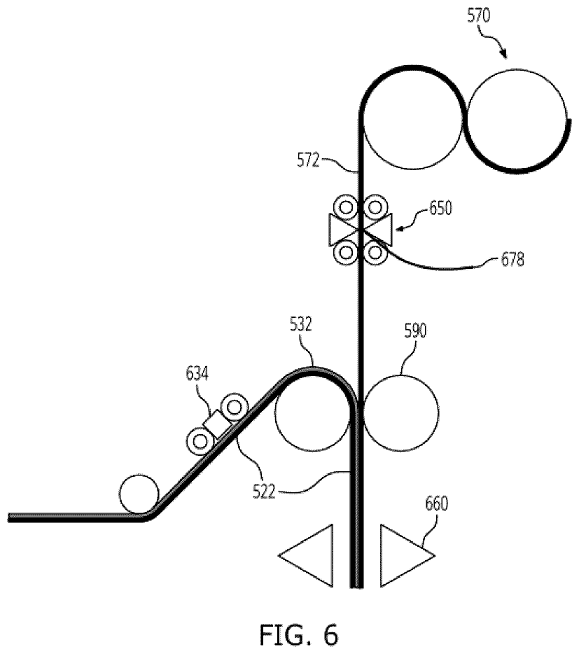

FIG. 5 illustrates a schematic view of a dry electrode manufacturing system 500 according to an embodiment of the present disclosure. Further, FIG. 6 illustrates the vicinity of a second calendering unit and a second laminating unit in the dry electrode manufacturing system according to an embodiment of the present disclosure.

Referring to FIGS. 5 and 6, the dry electrode manufacturing system 500 according to an embodiment of the present disclosure may include a first supply unit 510 configured to supply a first electrode powder 512 containing an active material, a first calendering unit 520 configured to press the first electrode powder 512 to produce a first electrode film 522, an unwinding (supplying) unit 530 configured to supply a current collector 532, and a first laminating unit 540 configured to bond the current collector 532 with the first electrode film 522. Descriptions of each components may be referenced from the description provided with reference to FIGS. 1 to 4.

In one embodiment, the dry electrode manufacturing system 500 may further include a second supply unit 560 configured to supply a second electrode powder 562 containing an active material and a second calendering unit 570 configured to press the second electrode powder 562 to produce a second electrode film 572. The composition of the second electrode powder 562 may be the same as that of the first electrode powder 512. The second calendering unit 570 may include a plurality of calendering rolls for pressing the second electrode powder 562, similar to the first calendering unit 520. The second electrode film 572 may be a free-standing dry electrode film manufactured from the second electrode powder 562.

The dry electrode manufacturing system 500 according to an embodiment may further include a second laminating unit 590 configured to bond the second electrode film 572 to the current collector 532, to which the first electrode film 522 is bonded. Specifically, the second laminating unit 590 may include a pair of opposing presses or a pair of lamination rolls. The second laminating unit 590 may bond the current collector 532, to which the first electrode film 522 is bonded, with the second electrode film 572 by placing the second electrode film 572 and the current collector 532 bonded with the first electrode film 522 between the pair of presses and applying pressure to them, or by passing the second electrode film 572 and the current collector 532 bonded with the first electrode film 522 between the pair of lamination rolls and compressing them. In embodiments, the presses or the lamination rolls may be heated to a temperature ranging from 80° C. to 250° C. to thermally compress the current collector 532 and the second electrode film 572.

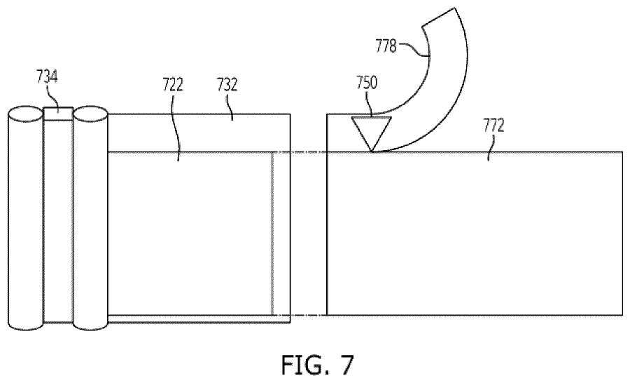

The dry electrode manufacturing system 500 according to an embodiment may further include a center position controller (CPC) 634 that aligns a position of the current collector 532 bonded with the first electrode film 522 before bonding it with the second electrode film 572. Specifically, before the current collector 532 bonded with the first electrode film 522 is supplied to the second laminating unit 590, the CPC 634 may adjust the relative positioning of the current collector 532 bonded with the first electrode film 522 in relation to the position of the second electrode film 572. This will be described in detail with reference to FIG. 7.

Although not illustrated, the dry electrode manufacturing system 500 may further include a second CPC (not shown) for aligning a position of the second electrode film 572 before bonding it with the current collector 532 bonded with the first electrode film 522.

In embodiments, the dry electrode manufacturing system 500 may further include a second cutting unit 650 configured to trim the second electrode film 572 to a specific width. The second cutting unit 650 may include a leading alignment roller, a trimming device, and a trailing alignment roller, similar to the first cutting unit 350 shown in FIG. 3. The descriptions of each of these components may be referenced from the descriptions provided above with reference to FIG. 3. A portion of the second electrode film 572, once trimmed (once cut), may be separated and removed as scrap 678. Further, the trimming width of the second electrode film 572 may correspond to the trimming width of the first electrode film 522.

Here, the first laminating unit 540 and the second laminating unit 590 may be spaced apart from each other. In contrast, a manufacturing method where the dry electrode films 522 and 572 are laminated simultaneously on both sides (opposite sides) of the current collector 532 is a highly complex process with respect to precise alignment between the first electrode film 522 and the second electrode film 572. But, according to embodiments of the present disclosure, by sequentially laminating the dry electrode films on both sides (opposite sides) of the current collector through separate laminating units that are positioned apart from each other, the process conditions and alignment requirements can be simplified, providing a dry electrode with uniform quality.

The dry electrode manufacturing system 500 according to an embodiment may further include a second sensor 660 configured to detect the bonding between the current collector 532 and the second electrode film 572. Here, the second sensor 660 may be disposed at a position below the second laminating unit 590. The second sensor 660 may include a visual sensor or a thickness sensor. Configurations of the visual sensor or thickness sensor are the same as those described above with reference to FIG. 3.

FIG. 7 illustrates a first electrode film 722 and a second electrode film 772 according to an embodiment of the present disclosure.

As shown in FIG. 7, the second electrode film 772 according to an embodiment of the present disclosure may be bonded in positional alignment with the first electrode film 722 disposed on the current collector 732. Specifically, a center position controller (CPC) 734 may adjust the relative positioning of the current collector 732, to which the first electrode film 722 is bonded, in relation to the position of the second electrode film 772 before the current collector 732 bonded with the first electrode film 722 is supplied to a second laminating unit (not shown).

In this embodiment, the second electrode film 772 may be trimmed by a second cutting unit 750 to have the same width as that of the first electrode film 722. Following bonding, the second electrode film 772 and the first electrode film 722 may be opposite to each other with the current collector 732 disposed therebetween. To achieve this, the first electrode film 722 and the second electrode film 772 may be laminated at symmetrical positions with the current collector 732 interposed therebetween.

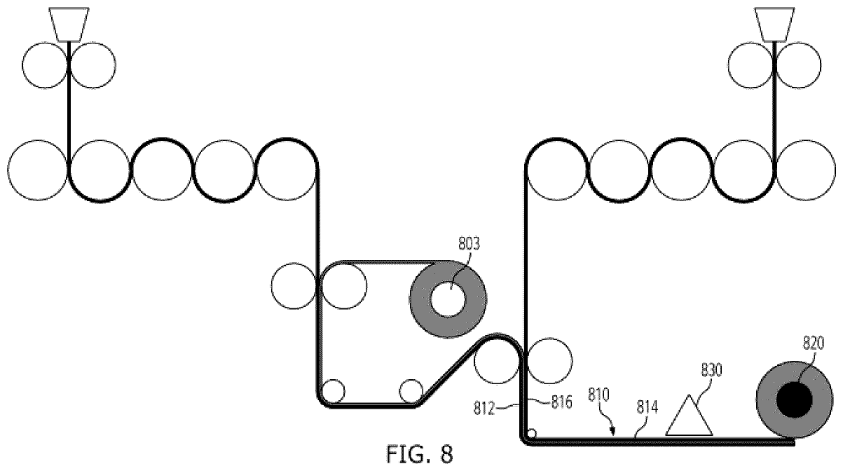

FIG. 8 illustrates a dry electrode manufacturing system according to an embodiment of the present disclosure.

Referring to FIG. 8, the dry electrode manufacturing system according to an embodiment of the present disclosure that further includes a rewinding unit 820 configured to rewind a dry electrode film 810 applied onto a current collector 814. Here, the dry electrode film 810 may include a first electrode film 812 and a second electrode film 816.

Through the operation of the unwinding unit 803, which performs the function of unwinding the wound current collector 814, and the rewinding unit 820, which performs the function of rewinding the current collector 814 bonded with the first electrode film 812 and the second electrode film 816, the electrodes can be moved in a constant direction and speed. This allows the dry electrode manufacturing system to continuously perform the dry electrode manufacturing process.

The dry electrode manufacturing system according to an embodiment of the present disclosure may further include a density measurement device 830 configured to detect the bonding of the current collector 814, to which the first electrode film 812 is bonded, and the second electrode film 816. The density measurement device 830 may utilize, for example, X-rays or Beta-rays to measure the density of the current collector 814 bonded with the first electrode film 812 and the second electrode film 816. By accurately measuring and regulating the density of the dry electrode using the density measurement device 830, the performance of the dry electrode can be optimized while maintaining consistent quality.

Although not illustrated, the dry electrode manufacturing system according to embodiments of the present disclosure may include a plurality of dancers, a guider, and an edge position controller (EPC). The dancers may control the amount of tension applied to the electrode such that the electrode is supplied while maintaining a certain range of tension. A change in the amount of tension applied to the electrode that is supplied through the guider may cause vertical or horizontal movements of the dancers, and such movements can be detected by a sensor or a controller, which in turn may allow for adjustments of the rotational speed and torque of the unwinding unit 803 and the rewinding unit 820. The edge position controller may adjust a position of the electrode by detecting an edge line of the electrode during the movement of the electrode by using optical sensors, laser sensors, and the like, thereby ensuring that the electrode remains accurately aligned. The arrangement and positioning of the dancers, the guider, and the EPC may vary depending on the manufacturing system. Further, multiple units of each component may be provided.

Other configurations of the dry electrode manufacturing system depicted in FIG. 8 can be referenced from the descriptions provided with reference to FIGS. 1 to 7.

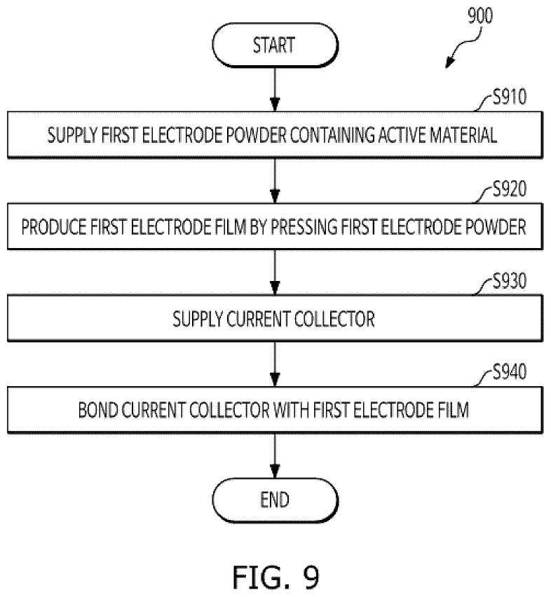

FIG. 9 is a flowchart of an example method of manufacturing a dry electrode according to an embodiment of the present disclosure.

A dry electrode manufacturing method 900 according to an embodiment of the present disclosure may begin with supplying a first electrode powder containing an active material (step S910). In embodiments, the step of supplying the first electrode powder may include supplying the first electrode powder in a direction perpendicular to a progress direction of a process of pressing the first electrode powder to form a first electrode film.

Subsequently, the first electrode powder may be pressed to form the first electrode film (step S920).

Thereafter, a current collector may be supplied (step S930).

Then, the first electrode film may be boned to the current collector (step S940). The current collector and the first electrode film may be heated and bonded by a laminating unit. Here, an unwinding (supplying) unit that supplies the current collector may be disposed at a position below the first calendering unit that produces the first electrode film. A cooling and stabilization process may be performed on the current collector and the first electrode film that are bonded together.

The dry electrode manufacturing method 900 according to embodiments of the present disclosure may further include a step of trimming the first electrode film to have a specific width, and the step of trimming the first electrode film may be conducted separately from the step of producing the first electrode film.

The dry electrode manufacturing method 900 according to embodiments of the present disclosure may further include a step of detecting the bonding of the current collector and the first electrode film.

The dry electrode manufacturing method 900 according to an embodiment of the present disclosure may further include a step of supplying a second electrode powder containing an active material and a step of pressing the second electrode powder to form a second electrode film.

The dry electrode manufacturing method 900 according to an embodiment of the present disclosure may further include a step of bonding the current collector, to which the first electrode film is bonded, with the second electrode film. Before the step of bonding the current collector and the second electrode film, the dry electrode manufacturing method 900 may include an additional step of aligning a position of the second electrode film or a position of the current collector.

The secondary battery including the dry electrode manufactured according to embodiments of the present disclosure may include lithium battery cells, sodium battery cells, and the like. However, the scope of the present disclosure is not limited to these examples, and the secondary battery includes all types of batteries capable of repeatedly providing electrical power through charging and discharging cycles. The secondary battery according to embodiments may be used in automobiles, mobile phones, and/or various other forms of electrical devices, and the present disclosure is not restricted to these applications.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: dry electrode manufacturing system
110: first supply unit
112: first electrode powder
120: first calendering unit
122: first electrode film
130: unwinding unit
132: current collector
140: first laminating unit

What is claimed is:

1. A system for manufacturing a dry electrode, the system comprising:
a supply unit configured to supply an electrode powder containing an active material;
a calendering unit configured to press the electrode powder to form an electrode film;
an unwinding unit configured to supply a current collector; and
a laminating unit configured to bond the current collector and the electrode film,
wherein the unwinding unit is disposed at a position below the calendering unit.

2. The system as claimed in claim 1, wherein the laminating unit or the calendering unit is disposed at a position below the supply unit.

3. The system as claimed in claim 2, wherein the electrode powder is supplied from the supply unit in a direction perpendicular to a direction in which the electrode film is calendered by the calendering unit.

4. The system as claimed in claim 1, further comprising at cutting unit configured to trim the electrode film to a specific width,
wherein the cutting unit is arranged at a distance from the calendering unit.

5. The system as claimed in claim 4, wherein the cutting unit comprises a trimming device, and the trimming device is disposed at a position below the calendering unit.

6. The system as claimed in claim 1, further comprising a sensor configured to detect bonding between the current collector and the electrode film,
wherein the sensor is disposed at a position below the laminating unit.

7. The system as claimed in claim 6, wherein the sensor comprises a visual sensor or a thickness sensor.

8. The system as claimed in claim 1, wherein the supply unit is a first supply unit, the electrode powder is a first electrode powder, the calendaring unit is a first calendaring unit, and the electrode film is a first electrode film, and
wherein the system further comprises:
a second supply unit configured to supply a second electrode powder containing an active material; and
a second calendering unit configured to press the second electrode powder to form a second electrode film.

9. The system as claimed in claim 8, wherein the laminating unit is a first laminating unit, and
wherein the system further comprises a second laminating unit configured to bond the current collector, to which the first electrode film is bonded, with the second electrode film.

10. The system as claimed in claim 9, further comprising a center position controller configured to align a position of either the second electrode film or the current collector before bonding the current collector, to which the first electrode film is bonded, with the second electrode film,
wherein the first laminating unit and the second laminating unit are arranged spaced apart from each other.

11. The system as claimed in claim 10, wherein the second electrode film is bonded in positional alignment with the first electrode film disposed on the current collector.

12. The system as claimed in claim 8, further comprising a cutting unit configured to trim the second electrode film to have a specific width,
wherein a trimmed width of the second electrode film corresponds to a trimmed width of the first electrode film.

13. The system as claimed in claim 1, further comprising a winding unit configured to wind a dry electrode film coated on the current collector.

14. The system as claimed in claim 9, further comprising a density measurement device configured to detect bonding between the current collector, to which the first electrode film is bonded, and the second electrode film.

15. A method of manufacturing a dry electrode, the method comprising:
supplying an electrode powder containing an active material;
producing an electrode film by pressing the electrode powder;
supplying a current collector; and
bonding the current collector and the electrode film,
wherein an unwinding unit that supplies the current collector is disposed at a position below a calendering unit that produces the electrode film.

16. The method as claimed in claim 15, wherein the supplying of the electrode powder comprises supplying the electrode powder in a direction perpendicular to a progress direction of a process of pressing the electrode powder to produce the electrode film.

17. The method as claimed in claim 15, further comprising trimming the electrode film to a specific width,
wherein the trimming of the electrode film is performed separately from the producing of the electrode film.

18. The method as claimed in claim 15, further comprising detecting bonding between the current collector and the electrode film.

19. The method as claimed in claim 15, wherein the electrode powder is a first electrode powder and the electrode film is a first electrode film, and
wherein the method further comprises:
supplying a second electrode powder containing an active material; and
producing a second electrode film by pressing the second electrode powder.

20. The method as claimed in claim 19, further comprising:
bonding the current collector, to which the first electrode film is bonded, with the second electrode film; and
aligning a position of either the second electrode film or the current collector before the bonding of the current collector and the second electrode film.
